(19) United States
(12) Patent Application Publication
(10) Pub. No.: US 2021/0029881 A1
(43) Pub. Date: Feb. 4, 2021

(54) PINE CONE COLLECTION APPARATUS

(71) Applicant: Samuel Lee Pridgon, Ty Ty, GA (US)

(72) Inventor: Samuel Lee Pridgon, Ty Ty, GA (US)

(21) Appl. No.: 16/941,411

(22) Filed: Jul. 28, 2020

Related U.S. Application Data
(60) Provisional application No. 62/879,688, filed on Jul. 29, 2019.

(51) Int. Cl. A01D 51/00; A01D 7/10

(52) U.S. Cl. CPC A01D 51/002; A01D 7/10

(57) ABSTRACT

A garden implement is directed to collecting fallen pine cones off the ground. The device has an elongated handle connected to a basket or cage having a bottom surface that slides on a ground surface. The basket or cage has closed sides, and an open distal mouth. The bottom surface may comprise a pitchfork with curved tines and forward points. In operation, a user pushes the basket or cage forward using the handle, and pine cones are collected for disposal. Side wheels may be added for additional versatility.

### REFERENCE TO RELATED APPLICATIONS

This application claims priority to and the benefit of U.S. Provisional Patent Application Ser. No. 62/879,688, filed Jul. 29, 2020, the entire content of which is incorporated herein by reference.

### FIELD OF THE INVENTION

This invention relates generally to garden tools and, in particular, to a manually operated pine cone collection tool.

### BACKGROUND OF THE INVENTION

Collecting pine cones from lawns and other yard surfaces can be a time-consuming and tedious task. Pine cones can be scattered across large areas, requiring repetitive bending over to retrieve them. Some pine cones can have relatively sharp edges, further aggravating the problem.

While there are pine cone collection devices disclosed in the prior art, they are either ineffective, costly, or both. One example is the device shown in U.S. Design Pat. No. D365, 570. While this unit may be manually directed, it is large and difficult to store. It also has moving parts and belts that can wear out and require maintenance.

The need remains, therefore, for a cost-effective yet versatile and effective pine-cone collection apparatus.

### SUMMARY OF THE INVENTION

This invention address the needs of the existing art by providing a garden tool for collecting pine cones off the ground. The device has an elongated handle connected to a basket or cage having a bottom surface that slides on a ground surface, closed sides, and an open distal mouth. The bottom surface may comprise a pitchfork with curved tines and forward points. In operation, a user pushes the basket or cage forward using the handle, and pine cones are collected for disposal. Side wheels may be added for additional versatility.

### BRIEF DESCRIPTION OF THE DRAWINGS

FIG. 1 is a top and forward view of a preferred embodiment of the invention;

FIG. 2 is a bottom view of the embodiment of FIG. 1;

FIG. 3 is a side view of the embodiment of FIG. 1;

FIG. 4 is a back view of the preferred embodiment; and

FIG. 5 is an oblique view of a preferred embodiment showing the way in which the implement may be used.

### DETAILED DESCRIPTION OF THE INVENTION

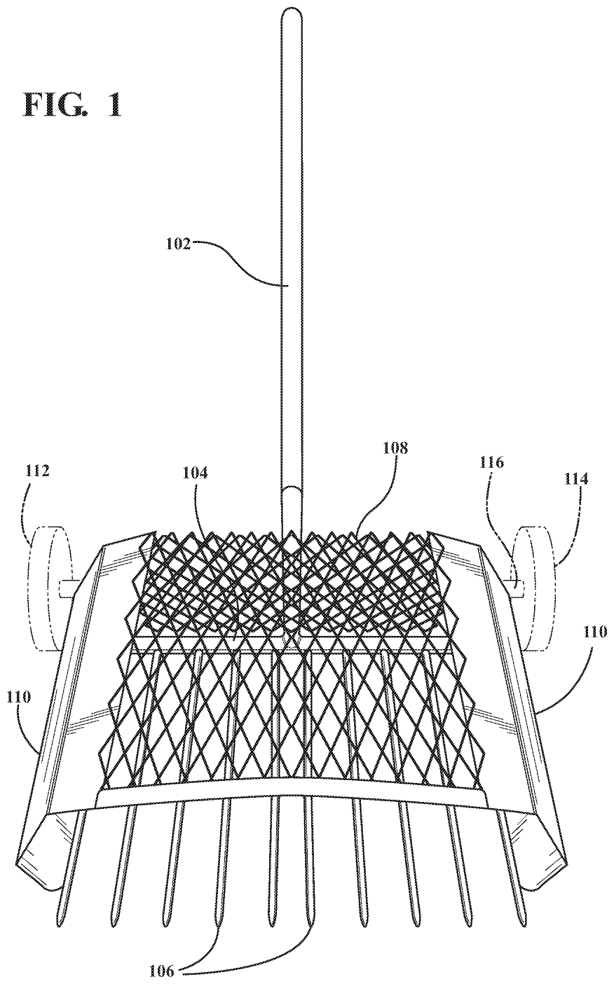

Now making reference to the accompanying drawings, FIG. 1 depicts a top and forward view of a preferred embodiment of the invention. The device broadly includes an elongated handle 102 connected to a lower fork structure. The lower fork structure comprises a support 104 from which there extends a plurality of tines 106. The handle 102 may be made of any suitable material such as wood or lightweight metal such as aluminum. The fork structure is preferably of a stronger rigid material such as aluminum or steel, including stainless steel. It is also possible to use some durable plastics for the handle and/or fork structure assuming sufficient strength and durability.

In the preferred embodiment, the fork structure may resemble a wide pitchfork, the bottom times of which exhibit a convex curvature to facilitate a smoother gliding action across the ground as the implement is pushed forward. To further ease operation, the lower rear portion of the overall mesh cage or basket structure described below may include opposing right and left wheels 112, 114. Wheels 112, 114, may be independently attached to the sides of the implement, or a common axle 116 may be provided upon which the wheels are journaled for rotation.

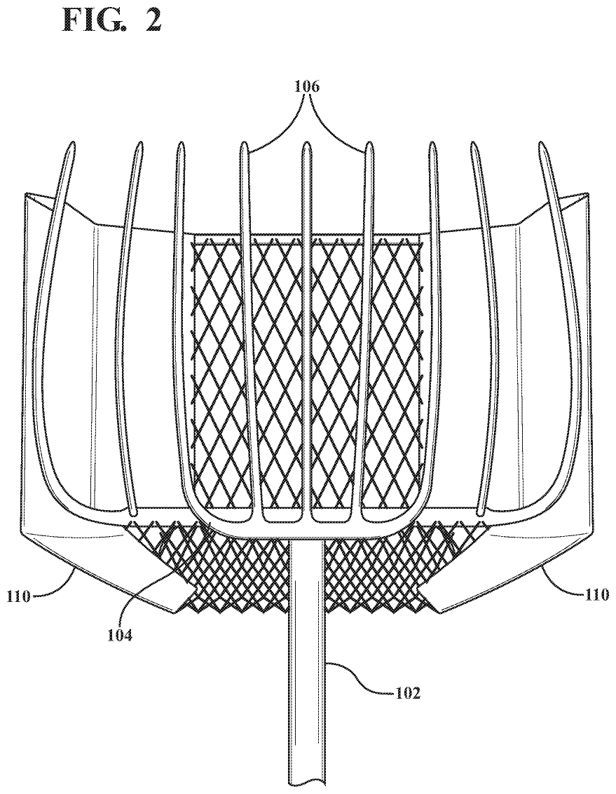

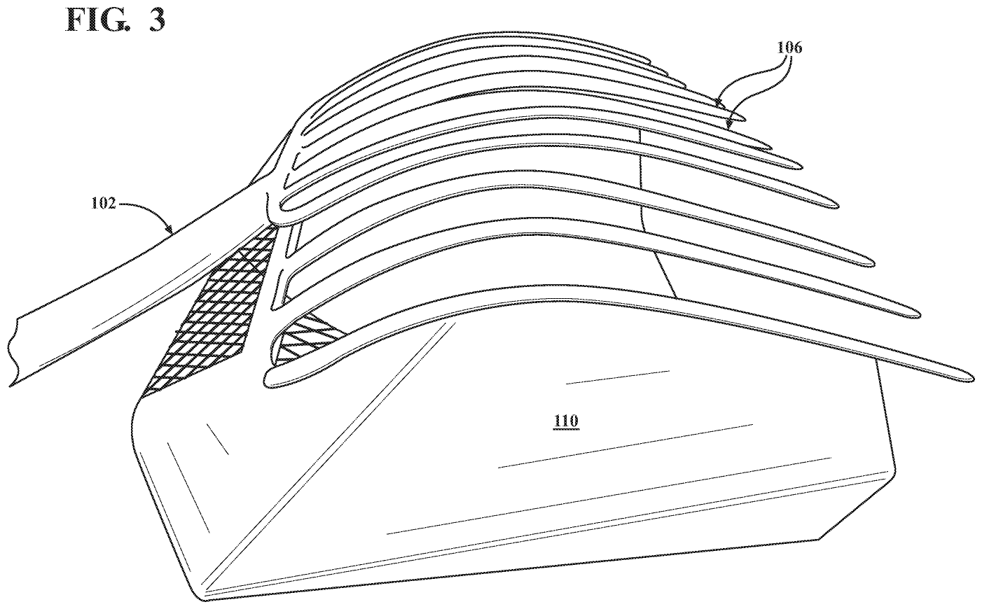

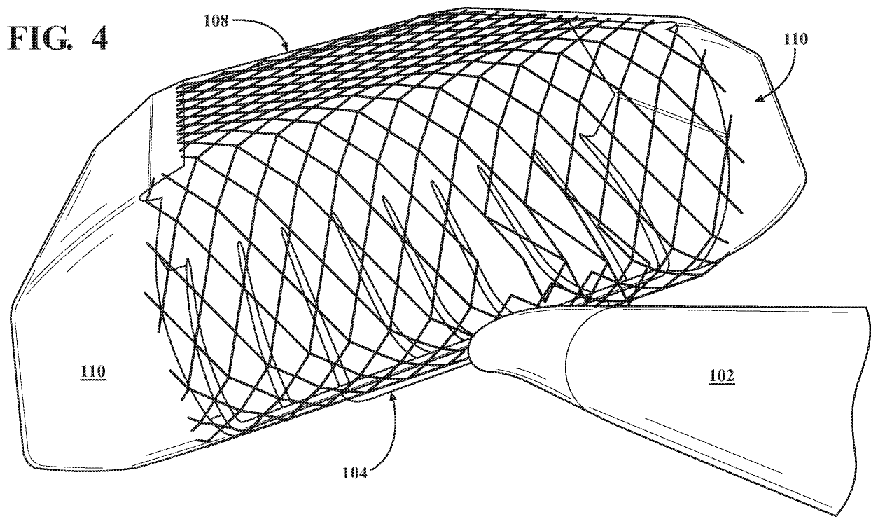

FIG. 2 is a bottom view of the implement; FIG. 3 is a side view, and FIG. 4 is a back or rear view. The apparatus further preferably includes smooth surfaces 110 on both sides to ease the pushing of the implement, with or without attached wheels. Connecting the side surfaces on the top is a mesh cage or basket material 108. In the preferred embodiment, the sides are sheet metal, and the cage or basket is metal mesh.

In operation, a user pushes the device along a ground or grassy surface, and pine cones are collected in the forward open mouth of the cage or basket structure. The size of the collector may vary depending upon the size of the cones and/or the number to be collected. Typically the open mouth may have a height in the range of 2 to 10 inches, with a width in the range of 4 to 20 inches. Note that the bottom of the fork structure is preferably curved from back to front, such that the device may be pushed forwardly and smoothly on the ground while adjusting the angle of the handle so as not to interfere with grassy surfaces.

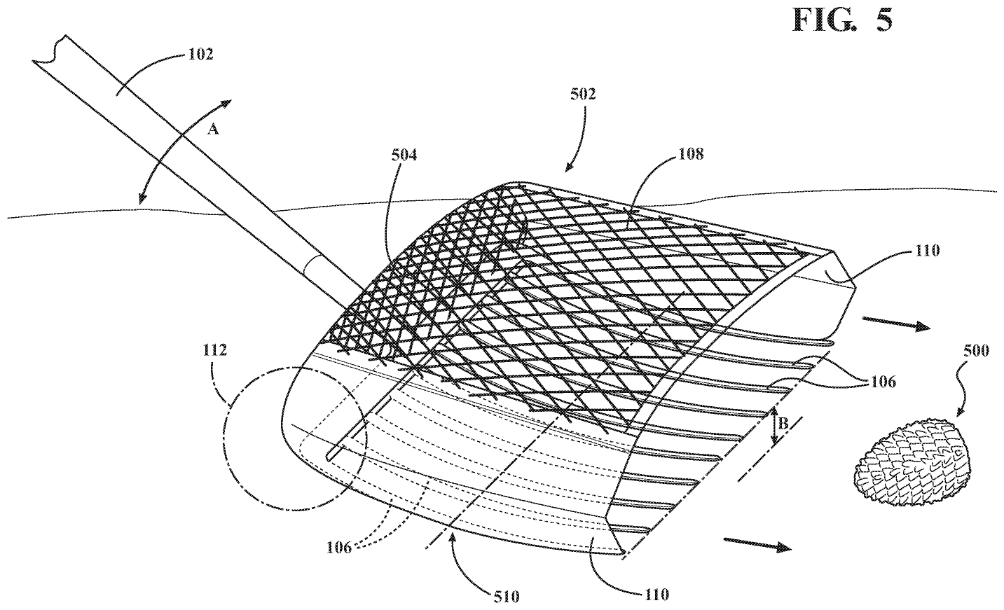

FIG. 5 is an oblique view of a preferred embodiment of the invention illustrating the way in which the implement may be used. Handle 102 is connected to collection structure 502 which effectively forms a rectangular box with a top 108, opposing sides 110, a rear wall 504 and a forward, open mouth. The implement is being pushed toward a pine cone 500 resting on a ground surface. In the preferred embodiment, at least the top 108 is made of a metal mesh enabling the user to visualize a basket fill level. Sides 100, may also be mesh or sheet metal.

The bottom of the basket structure is defined by a plurality of curved times 106 that together form partial cylindrical convex surface enabling the basket to better slide along the ground surface as the handle 102 is pushed. Note also that the convex lower curvature of the basket forms a pivot line from side to side, such that as the handle is pivoted up and down (A), the distance from the bottom of the open mouth to the ground surface (B) may be varied, further assisting in the collection process. Optional wheels (112) may further assist with forward movement and/or establish additional lower, rear pivot point to adjust distance B.

While the device shown is constructed from available materials, including a commercially available pitchfork, it will be appreciated by those of skill that other constructions are possible based upon manufacturing and packaging considerations. For example, the handle 102 may be provided in sections to ease shipping requirements. While the mesh/basket panels may be solid, the mesh/basket is more desirable for visualization of collected contents. When the collector is full, it may simply be brought to a canister or dump site for removal and continued operation.

1. A pine cone collection apparatus, comprising:
an elongated handle having a proximal end and a distal end coupled to a pine cone collection structure;
wherein the pine cone collection structure includes a top, a bottom, opposing sides, a back and an open, forward mouth;
wherein the bottom of the pine cone collection structure defines a plane with an outward, front-to-back convex curvature;
whereby a user pushes the pine cone collection structure forwardly such that fallen pine cones on a ground surface enter into the open, forward mouth and are retaining therein; and
wherein the front-to-back convex curvature of the bottom of the pine cone collection structure facilitates a sliding movement along a ground surface as a user pushes the apparatus, while further allowing the user to adjust the distance of the open mouth relative to a ground surface by tilting the elongated handle up and down.

2. The pine cone collection apparatus of claim 1, wherein the bottom of the pine cone collection structure is formed by a plurality of elongated, curved tines extending from front to back.

3. The pine cone collection apparatus of claim 1, wherein at least the top of the pine cone collection structure is constructed of a wire mesh or basket material.

4. The pine cone collection apparatus of claim 1, wherein the sides of the pine cone collection structure are constructed of sheet metal.

5. The pine cone collection apparatus of claim 1, wherein the opposing sides of the pine cone collection structure further include right and left opposing wheels.

6. The pine cone collection apparatus of claim 1, wherein the open mouth of the pine cone collection structure has a height in the range of 2 to 10 inches and a width in the range of 4 to 20 inches.

7. A pine cone collection apparatus, comprising:
an elongated handle having a proximal end and a distal end coupled to a pine cone collection basket;
wherein the collection basket includes a top, a bottom, opposing sides, a back and an open, forward mouth;
wherein the bottom of the collection basket is formed with a plurality of curved, elongated tines defining a convex lower curved surface from front to back enabling the collection basket to slide on a ground surface when pushed; and
wherein at least the top of the collection basket includes a mesh structure enabling a user to determine a fill level of the collection basket during use.

8. The pine cone collection apparatus of claim 7, wherein the sides of the pine cone collection basket are constructed of sheet metal.

9. The pine cone collection apparatus of claim 7, wherein the opposing sides of the pine cone collection basket further include right and left opposing wheels.

10. The pine cone collection apparatus of claim 9, wherein the opposing wheels are positioned at the lower rear portion of the collection basket and act as pivots enabling a user to move the handle up and down to adjust the distance between the open mouth of the collection basket and a ground surface.
